(19) United States
(12) Patent Application Publication
(10) Pub. No.: US 2023/0368321 A1
(43) Pub. Date: Nov. 16, 2023

(54) ARTIFICIALLY INTELLIGENT EMERGENCY RESPONSE SYSTEM

(71) Applicant: Deep Detection LLC, Troy, NY (US)

(72) Inventors: Alexander Bringsjord, Rensselaer, NY (US); Selmer Bringsjord, Rensselaer, NY (US); Paul Spadaro, Albany, NY (US); Naveen Sundar Govindarajulu, San Jose, CA (US)

(21) Appl. No.: 18/195,613

(22) Filed: May 10, 2023

Related U.S. Application Data
(60) Provisional application No. 63/340,184, filed on May 10, 2022.

(51) Int. Cl. G06Q 50/26

(52) U.S. Cl. CPC G06Q 50/26

(57) ABSTRACT

A system, method and program product for implementing an artificially intelligent emergency response system to generate a plan for an emergency event in response to received event information from one or more input devices. A process includes: translating the received event information into a logically controlled natural language; selecting a meta-model that conforms to the emergency event; generating a hypergraph model from the meta-model, wherein the hypergraph model includes details from the received event information; generating a goal based on the received event information; generating and outputting a plan to an output device based on the hypergraph model, the goal, and semantic information.

### PRIORITY

This application claims benefit to co-pending provisional application filed on May 10, 2022, Ser. No. 63/340,184, entitled Intelligent First Responder System, the contents of which are hereby incorporated by reference.

### BACKGROUND

### 1. Technical Field

This invention relates generally to Artificial Intelligence, and more particularly to an artificial intelligence (AI) system and method for generating models and plans for emergency responders.

### 2. Related Art

Emergency responders face any number of challenges when dealing with an emergency. In a typical case, responders must digest the information being provided, and then react accordingly. However, many emergencies can be fluid with the information and situation changing over time. For example, an active shooter situation may evolve into a hostage negotiation situation, or a reported house fire may turn out to be a multiple house fire, etc. In such cases, the responders need to be able to react as the situation unfolds. Unfortunately, the responder may not have adequate information, training or equipment to handle such situations.

### SUMMARY

The present invention provides an artificial intelligence platform for generating models and plans for emergency responders, including both human and artificial agents.

In a first aspect, the invention provides an artificially intelligent emergency response system, comprising: a memory; and a processor coupled to the memory and configured to generate a plan for an emergency event in response to received event information from one or more input devices, according to a process that includes: translating the received event information into a logically controlled natural language; selecting a meta-model that conforms to the emergency event; generating a hypergraph model from the meta-model, wherein the hypergraph model includes details from the received event information; generating a goal based on the received event information; and generating and outputting a plan to an output device based on the hypergraph model, the goal, and semantic information.

In a second aspect, the invention provides an artificially intelligent method for implementing an emergency response plan, comprising: receiving event information from one or more input devices; translating the received event information into a logically controlled natural language; selecting a meta-model that conforms to the emergency event; generating a hypergraph model from the meta-model, wherein the hypergraph model includes details from the received event information; generating a goal based on the received event information; and generating and outputting a plan based on the hypergraph model, the goal, and semantic information.

### BRIEF DESCRIPTION OF THE DRAWINGS

FIG. 1 depicts an AI emergency responder (AIER) platform in accordance with an embodiment of the invention.

FIG. 2 depicts a flow diagram of a process for an AIER platform in accordance with an embodiment of the invention.

FIG. 3 depicts a cognitive-likelihood continuum in accordance with an embodiment of the invention.

FIG. 4 depicts a hypergraphical node format in accordance with an embodiment of the invention.

FIG. 5 depicts a hypergraphical meta-model in accordance with an embodiment of the invention.

FIG. 6 depicts a hypergraphical model in accordance with embodiments of the invention.

FIG. 7 depicts a hypergraphical model in accordance with an embodiment of the present invention.

FIG. 8 depicts cognitive calculus levels in accordance with an embodiment of the invention.

FIG. 9 depicts an overview of a high-level anatomy of cognitive calculus in accordance with an embodiment of the invention.

FIG. 10 depicts a rip and run example.

FIG. 11 depicts a computing system in accordance with an embodiment of the invention.

### DETAILED DESCRIPTION

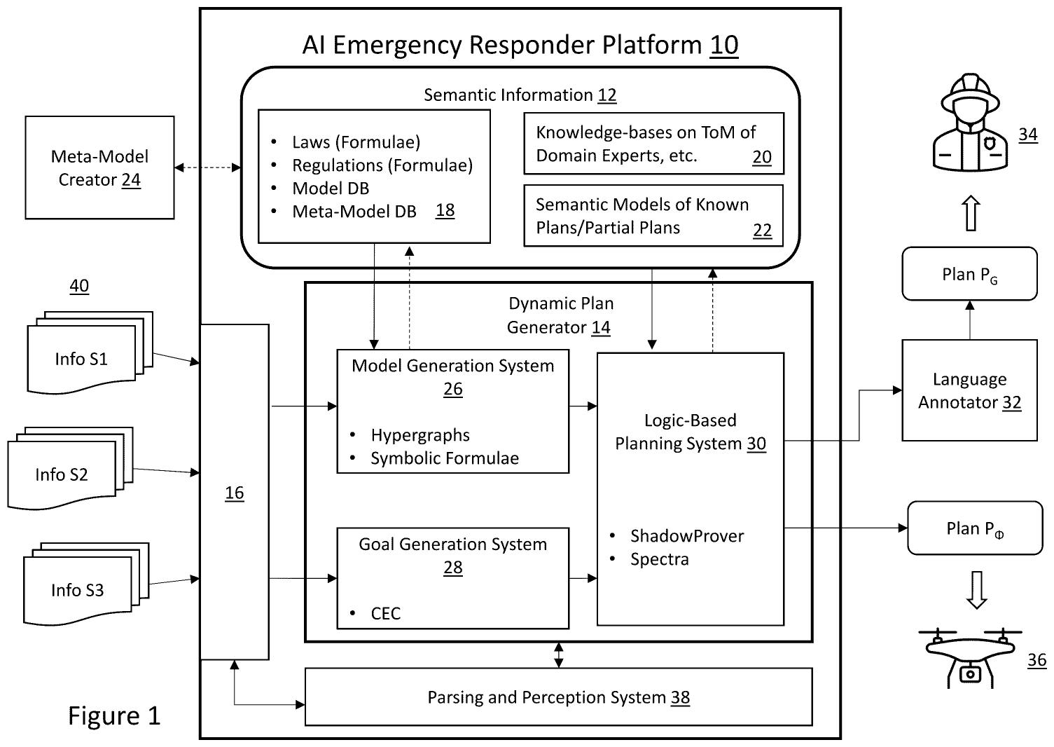

Referring now to the drawings, FIG. 1 depicts an artificial intelligence (AI) emergency responder platform 10 that receives event information 40 from various sources S1, S2, S3 associated with an emergency, and generates plans (P_{G}, P_{Φ}) for human responders 34 and/or artificial agents 36. Event information may be collected from any type of input device, e.g., sensors, speakers, microphones, scanners, cameras, text inputs, computer systems, dispatch systems, etc. Platform 10 generally includes semantic information 12, a dynamic plan generator 14, and an information processor 16. Semantic information 12 provides formalized knowledge of emergency response domains, which is used as the basis to create plans. Dynamic plan generator 14 is the engine that creates (and re-creates) models and plans for a current emergency event based on event information 40 and semantic information 12. Information processor 16 is responsible for receiving event information 40, e.g., in a natural language (NL) form, and converting the event information 40 into a dedicated, highly expressive formal language for modeling and resolving emergencies, denoted as [symbol] ERR. Information processor 16 operates in conjunction with a parsing and perception system that continuously parses and evaluates incoming information 40 during an emergency event.

For the purposes of this disclosure, the term “event information 40” refers to any data associated with a current emergency event, and may include structured and unstructured text, speech, image data, audio data, geospatial data, etc. Furthermore, it is understood that event information 40 may originate from any source, including human generated, computer generated, AI generated, sources. As an emergency event unfolds and event information 40 is received, all such data is translated into formulae at an appropriate level in a logically controlled natural language specifically tailored for emergency response and rescue, referred to herein as [symbol] ERR.

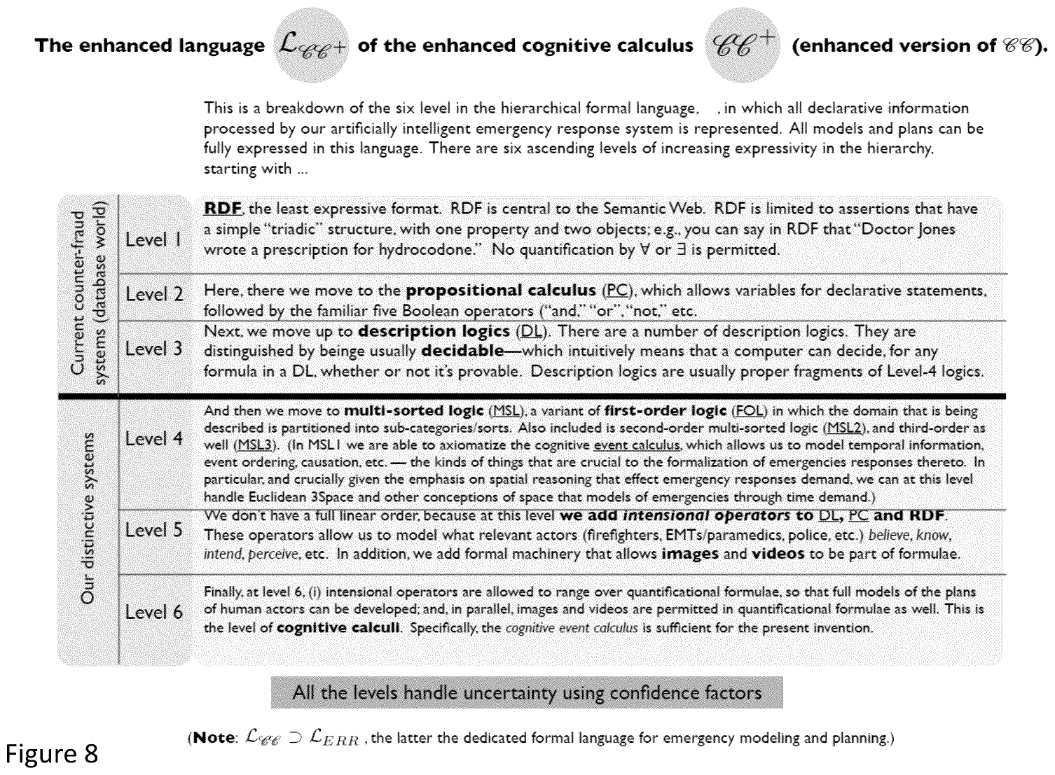

(Note that the event information 40 may also be saved in its original form for additional AI processing, such as using or training a large language model.) In some embodiments, the language [symbol] ERR is a sub-language of an enhanced version of a comprehensive, six-level, hierarchical formal Cognitive Calculus based language CC described in U.S. Pat. No. 11,379,732 B2, the contents of which is hereby incorporated by reference. FIG. 8 depicts an overview of CC in its currently enhanced form, referred to herein as CC+. This formal language has been expanded in three principal ways relative to the '732 patent, including:
1. Level 4 is now expanded to include not just multi-sorted logic (MSL) at the first-order level, but also second-order MSL (MSL2) and third-order MSL (MSL3). This entails that Levels 5 and 6 are expanded relative to the '732 patent. In the case of Level 5, the intensional operators introduced at that level and that distinguish it, are now allowed to range not over only formulae in MSL, but also MSL2 and MSL3.
2. In addition, in the present embodiment, the language CC+ has now been augmented to become spatial one as well. Given this, the current comprehensive logic qualifies as a spatial logic. Because emergencies occur and unfold in three-dimensional space, and because location, access, distance, etc., are so important in emergencies, spatial representation and reasoning have been introduced.
3. The enhanced formal language includes, at Level 5 and Level 6, not just the addition of intensional operators, but also the addition of images and videos. Data in the form of images and video is indispensable in the modeling and resolution of emergencies, as is well-known. For images, the language CC+ represents them as diagrams, e.g., used in the logic Vivid, introduced and specified in (Arkoudas and Bringsjord 2009). FIG. 8 reflects this third augmentation.

Referring again to FIG. 1, as the event information 40 flows into platform 40, it is translated by information processor into [symbol] ERR and fed to model generation system 26 and goal generation system 28. A model of the current emergency may for example be created based on a meta-model selected from a meta-model database 18, as well as other semantic information 12 such as laws and regulations expressed as formulae. A generated model may for example be represented as a hypergraph GM and/or as symbolic formulae Φ_{M}, and, e.g., details the actors involved, the type of emergency, available equipment and resources, etc., relationships, mental states, beliefs, knowledge, etc. Goal generation system 28 is responsible for generating a goal γ, e.g., extinguish the fire, clear the accident, stabilize an injured party, lockdown a site, etc., which can be represented in cognitive event calculus (CEC), a logic-based formalism for representing actions and their effects.

Goal generation system 28 may for example be implemented as follows. The instant a notification of an emergency is received, parsing and perception system is activated, and while being assessed for intrinsic credibility, or a belief by the human fielding the notification that this is indeed a real emergency: select from the part of the ontology what type of emergency is believed to be transpiring. The goal then is simply to resolve that emergencies.

Note that after the model (and goal) are generated, they can be stored in a model database as part of the semantic information 12 for future use. As noted, meta-models, which are described in further detail herein, form the basis for creating models, i.e., they provide the underlying model structure for different emergency scenarios (e.g., car accident, search and rescue, fire, etc.). Meta-models may for example be created with a meta-model creator 24, e.g., using (1) manual engineering; or (2) automated induction applied to models, which can be created by generative AI applied to known prior models, suitably encoded.

Generating models with such inductive automated reasoning performed on content expressed in the formal language of the enhanced cognitive calculus can be done as follows. Namely, the enhanced calculi can be used to process a collection of N particular models given as input, and compile by inductive reasoning these into M meta-models (where M<<N). The meta-models hold information common to a subset of the N particular models in compact, instantiable fashion. Inductive reasoning here is achieved via various proof methods; generalization and anti-unification are two methods used for this purpose.

Once the model and goal are generated, they are forwarded to logic-based planning system 30 that generates a plan P. In one embodiment, planning system 30 receives the model both as hypergraph G_{M} and a symbolic formulae Φ_{M}, and a plan P is generated for both input types that, to a high level of probability (or likelihood) will secure that goal γ given the model currently assumed. In one approach, logic-based planning system 30 is implemented using existing tools, Spectra™ and ShadowProver™, which utilize semantic information 12, namely knowledgebases 20 on Theory-of-Mind (ToM) of domain experts, investigators, auditors, etc., and semantic models of known plans and partial plans 22. Spectra provides a mechanism for generating new plans based on an inputted goal, and ShadowProver provides a mechanism for logically testing plans to ensure they meet requirements of a response. As such, each resulting plan is evaluated as a proof to determine if it meets the goals of the response, e.g., ShadowProver will attempt to prove whether the response can be implemented as required, e.g., by domain experts and the like.

As noted, parsing and perception system 38 continuously analyzes event information as it is received and processed in platform 10 to ensure that a current model and/or plan are viable. From the initial input of event information 40 to final output of a plan, dataflow from each module to a next can be examined by parsing and perception system 38 to ensure viability. If a current model or plan is deemed no longer viable, parsing and perception system 38 may void the current approach, and cause a new model and/or a new plan to be created. A plan, model, argument, proof, proposition in a knowledge base, etc.; all such are defeasible, which entails that as new information arrives, any of these elements can be defeated (i.e., refuted, contradicted, supplanted with something more likely, etc.).

Evaluating a current model and or plan for viability may for example be accomplished with an automated reasoner (such as that detailed in the '732 patent), which operates over content expresses in the enhanced highly expressive 6-level language [symbol] ERR. In the case of analyzing a model for viability, one type of defeat of a model happens when new information that is of higher level of likelihood or probability literally contradicts one or more formulae in the model that is used as a premise. For example, assume there was an initial report of accident involving two cars, and then later multiple reports were received that the accident involved several cars and a truck rollover. Because the later reports were received via eyewitnesses at the scene, the later reports may be assigned a higher score of cognitive-likelihood than the earlier report. This would potentially require a new model, e.g., one that involves a truck rollover. The automated reasoner continuously runs to see if there is an inconsistency between new declarative information 40 that is parsed and perceived into the platform 10, and the current, operative model. If an inconsistency is detected (where, again, the new information that leads to inconsistency is sufficiently likely/probably relative to that which is contradicts), the model generation system 26 is re-engaged to create a new model. Likewise, a new goal may be required, which would be generated by goal generation system 28.

In the case of analyzing a current plan for viability, the automated reasoner may evaluate various conditions, e.g., preconditions for actions that are part of the operative plan no longer hold (e.g., a road is closed) and the current plan will fail. Postconditions (i.e., things which become true after actions in a plan are performed) may likewise be continuously checked, which were they to become true, would be logically inconsistent with any states-of-affairs/propositions that must not be violated. For example, a law or regulation (stored as semantic information 12) would be broken. If such an inconsistency is detected, then planning system 30 must be called to search for a different plan that is consistent with present knowledge and belief. A third condition that could trigger re-planning is if the automated reasoner is able to establish that there is some inconsistency “inside” an agent with what is newly parsed and perceived. In embodiments described herein, every agent has capabilities formally defined by functions that take percepts to actions, i.e., plans consist of actions to be performed. Accordingly, an agent that is suddenly disabled will have a different set of functions that define its capabilities. If some key capacity needed for performing one or more actions in a plan is lost, the automated reasoner will detect this inconsistency, and cause a new plan to be generated. A description of defeasible automated reasoning is for example described in Bringsjord, S., Giancola, M. & Govindarajulu, N. S. (2023), “Logic-Based Modeling of Cognition,” in Sun, R., ed.,The Cambridge Handbook on Computational Cognitive Sciences (Cambridge, UK: Cambridge University Press), pp. 173-209. A preprint can be obtained via this link: http://kryten.mm.rpi.edu/SBringsjord_etal_L-BMC_121521.pdf the contents of which is hereby incorporated by reference.

In the illustrative embodiment, two plans are generated, P_{G} that is intended for human responders 34 and P_{Φ}that is intended for autonomous action by artificial agents (e.g., drones, robots, IoT systems, smart medical equipment, etc.). P_{G} may be output in any form suitable for human understanding, e.g., as a list of steps displayed on a tablet, as a map, audio instructions, augmented reality displays, etc. In some embodiments, P_{G} is generated as a phased series of visual hypergraphs, viewable on display device, annotated with cogent expressions (e.g., in English), by language annotator 32. In still further embodiments, P_{G} comprises a visual hypergraph annotated with spatial details, e.g., a directional compass rose, a map grid, landmarks, etc. P_{Φ}may be generated in any format suitable for an artificial agent. In other embodiments, maps are generated from the hypergraphs.

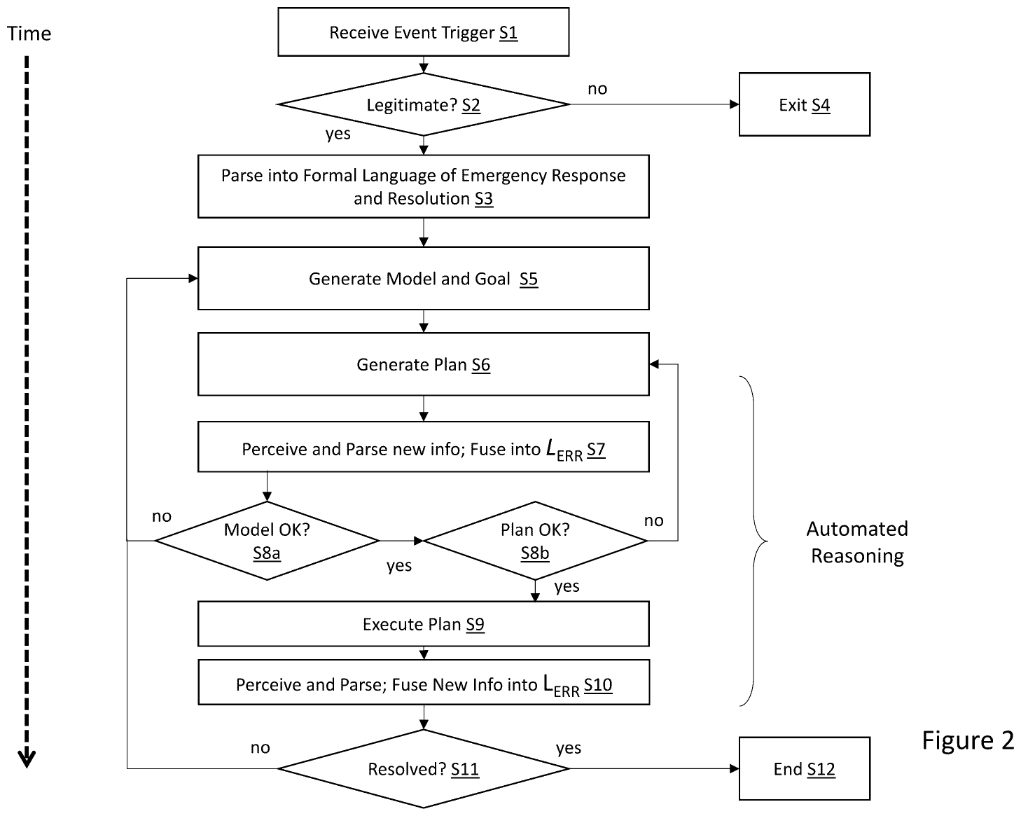

FIG. 2 depicts an illustrative embodiment of a process of implementing platform 10. At S1, an event trigger is received (e.g., a 911 call, etc.) and at S2 a determination is made whether the event trigger is legitimate. If no, the system exits at S4. If yes, at S3, the available information is parsed and translated into the formal language for modeling and resolving emergencies, i.e., [symbol] ERR. Next, a model and goal are generated at S5 and at S6, a plan is generated for a response. At S7, any new information is collected and fused into [symbol] ERR, and the model and plan are analyzed by perceive and parse system for viability. At S8a, if the current model is not OK, then a new model and goal are generated at S5. If the current model is Ok at S8a, then a check is made whether current plan is OK at S8b. If no, then a new plan is generated at S6. If yes, the plan is executed at S9. At S10, any new information is again collected and fused into [symbol] ERR, and the model and plan are analyzed by perceive and parse system to determine whether the emergency has been resolved. If the emergency is resolved at S11, the process ends. If not, the process loops back to S5 where a new model and plan are generated. Note that automated reasoning to determine whether the model and/or plan are viable may be continuously implemented throughout the process.

As noted, [symbol] ERR is a subset of Level 6 CC+. The following is an example of transforming a natural language (NL) string into a Level-6 formula in Assume an emergency trigger event has been received (and has been deemed more likely than not to be credible) from a dispatcher to first responders (e.g., an EMT and a firefighter) who then proceed via two vehicles (e.g., an ambulance and a firetruck) to a currently estimated location of a reportedly single-car vehicular accident on the way. Assume a NL input s:

s: “The caller said he sees a bunch of indicators that the car might catch on fire.”

In the above sentence s, a modal operator S (distinctive of at least Level 5) for one agent communicating to another is needed, as is a modal operator P, also from Level 5 and above, for an agent's perceiving information. In addition, the indicators are properties that imply, in the mind of the caller, that since they are possessed by one or more objects, a fire is soon possible. This means that the caller has a certain belief, which calls minimally for Level-5 expressive power and the operator B, and that the concept of physical possibility is in play, and important. There are also temporal factors implicit in what the caller here says (e.g., that what is perceived is at a time before any fire has started), but these factors are left aside at the moment. In addition, the dispatcher's statement uses the representational machinery of MSL2, at Level 4. Finally, many key propositions in emergency response and resolution are uncertain, and moreover likelihood measures and/or probabilities are important. The following is the formula that logicizes the English statement in question, pretty printed, where d is a constant used to denote the dispatcher and c a constant that denotes the caller:

[symbol]

s [symbol] : S(dispatcher, P(caller, ∃R₁∃R₂∃x(Car(x)∧∀y(X(y)→ [symbol] On_Fire(x)))))).

As a result, the responders on the way who receive this transmission believe, at the level of likelihood very likely that what is reportedly perceived by the caller holds; i.e., in a Level-6 formula:

B³(responders, ∃R₁∃R₂∃x(Car(x) ∧∀y(X(y)→ [symbol] On_Fire(x)))).

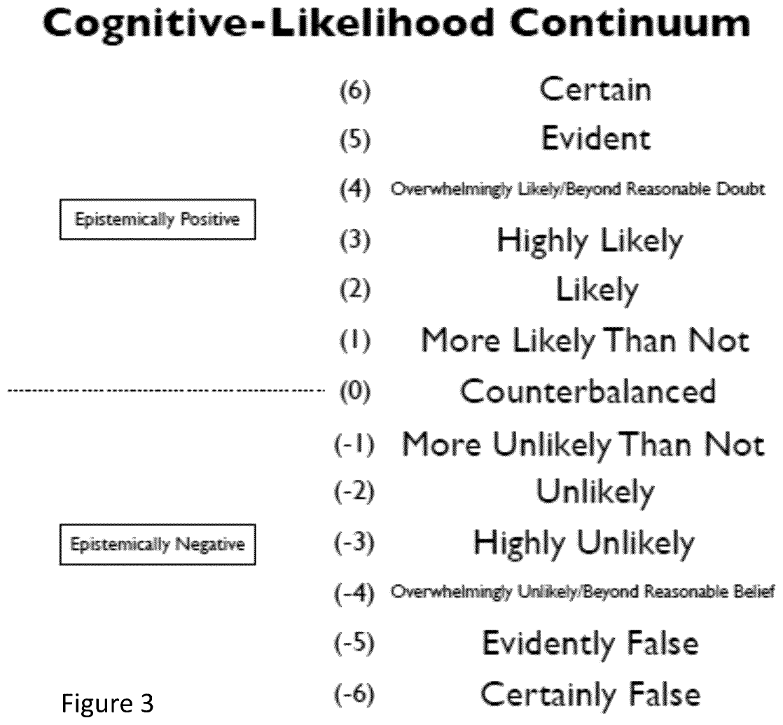

Notice the superscript ‘3’ on the belief of the responders. This is the integer value corresponding to a belief that Φ is highly likely. FIG. 3 depicts an illustrative spectrum of a cognitive-likelihood continuum used in CC+. Any time new information is received, e.g., that is subject to human belief, a cognitive-likelihood value is assigned to the information. The value may be used to keep or discard the information, to defeat an existing model or plan, etc. Cognitive-likelihood is for example described in Bringsjord, S.,˜Govindarajulu, N. S.\\& Giancola, M.\(2021), “Automated Argument Adjudication to Solve Ethical Problems in Multi-Agent Environments” \textit{Paladyn, Journal of Behavioral Robotics}\textbf{12.1}: 310-335. https://www.degruyter.com/document/doi/10.1515/pjbr-2021-0009/pdf, the contents of which is hereby incorporated by reference.

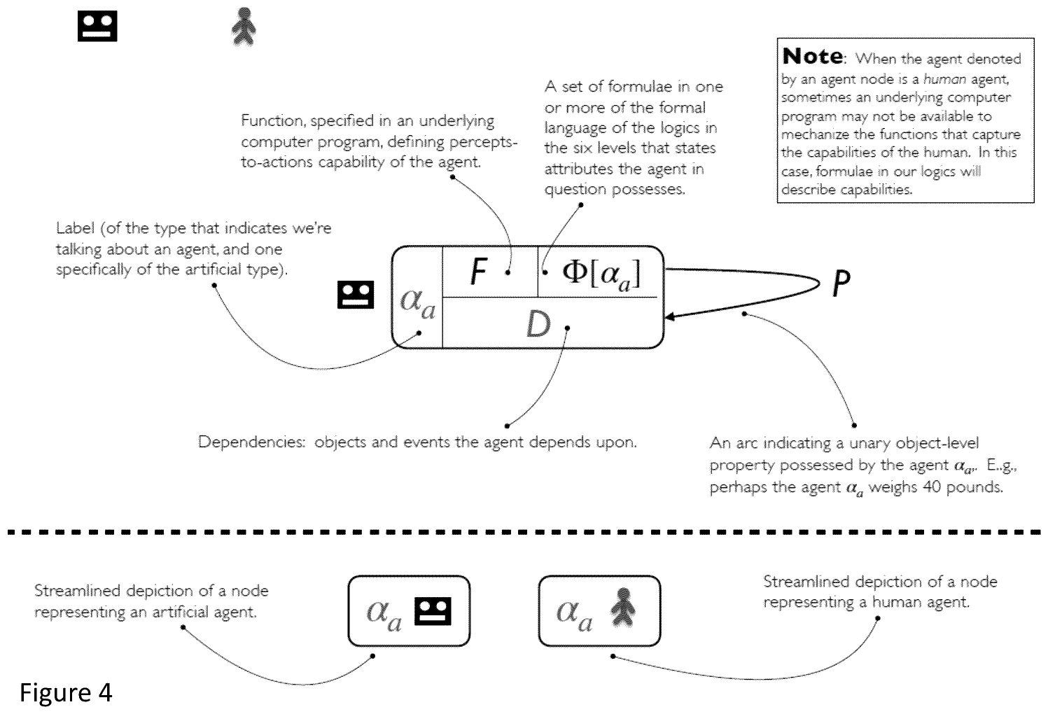

FIGS. 4-7 depict various diagrams detailing the implementation of hypergraphical meta-models and models. Hypergraphs generally comprise nodes and arcs, and have certain unique characteristics relative to other types of graphs, e.g., arcs can be bidirectional and circular. FIG. 4 depicts an anatomy of nodes in hypergraphs that describe agents, which as shown on the bottom may include artificial agents and/or human agents. Agents of either kind are distinguished by the fact that they compute functions F from perceptions to actions (e.g., spray foam when fire is detected). Further each agent node includes a set of formulae Φ in Level 6 that states attributes the agent possesses (e.g., beliefs, knowledge, percepts, etc.). Further, agents may include dependencies D which include objects or events that the agent depends upon (e.g., a tow truck driver depends on a tow truck), and unary properties P possessed by the agents (e.g., the agent weighs 200 pounds).

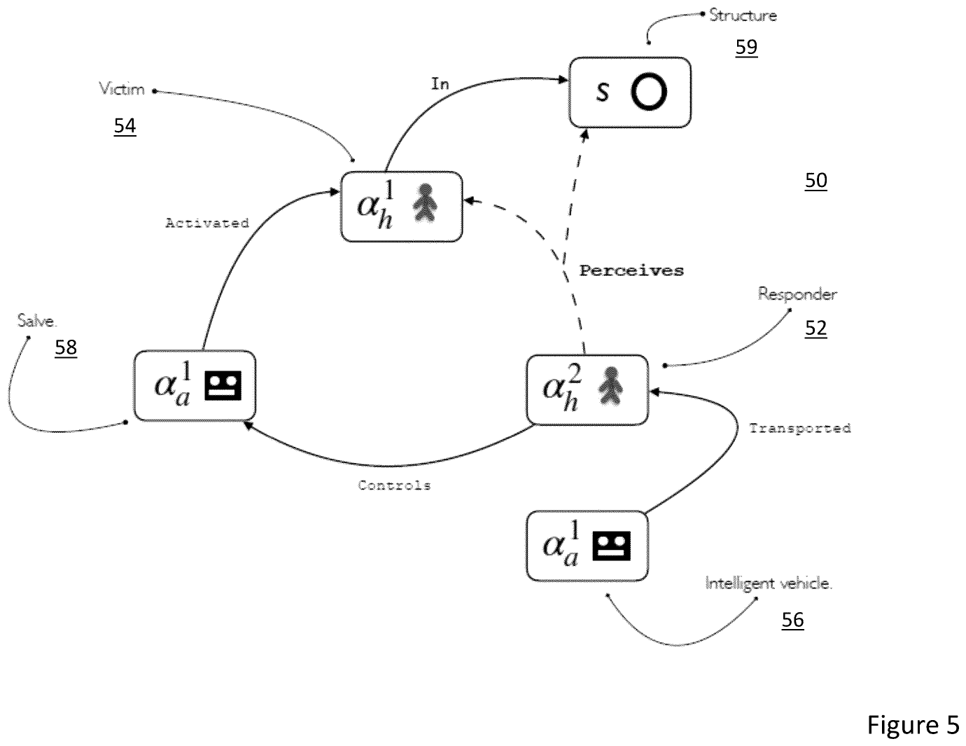

FIG. 5 depicts a hypergraphical meta-model 50 for a timepoint, which essentially is one of many emergency blueprints upon which a complete model can be built. In this case, there are two human agents, including a responder 52 and a victim 54, and two artificial agents, which include an intelligent vehicle 56 and a salve 58 (e.g., equipment, a defibrillator, water, fire hose, etc.). In addition, the meta-model 50 includes a structure 59 (e.g., a building) and various arcs, e.g., dependencies and perceptions. For example, the responder 52 controls the salve 58, the salve is activated on the victim 54, the victim 54 is in the structure 59, the vehicle 56 transports the responder 52, and the responder 52 perceives things about the victim 54 and the structure 59. When a trigger event occurs, or at different points in time, model generation system 26 in platform 10 (FIG. 1) will analyze available information 40 and select a meta-model that best maps to the information 40. Once the meta-model is selected, a hypergraphical model is generated.

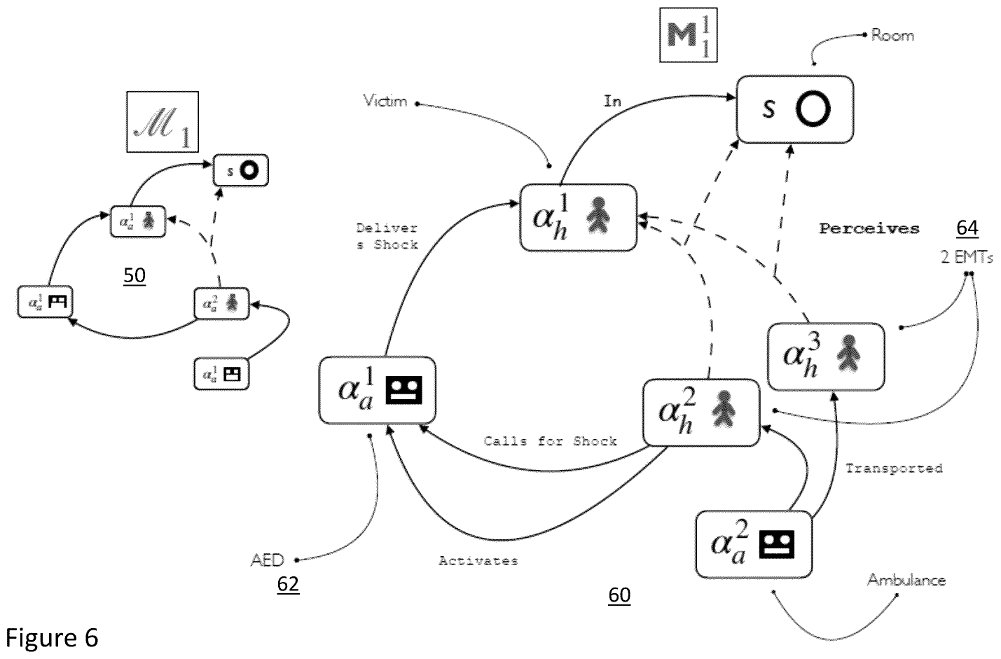

FIG. 6 depicts an illustrative hypergraphical model 60 generated using metamodel 50 for addressing a cardiac emergency via an EMT (emergency medical technician) using an AED (automated external defibrillator). in the system, i.e., model 60 is a particular instantiation of a hypergraphical meta-model 50. Accordingly, meta-models for different types of emergencies are able to be instantiated in different particular ways, without altering the structure of the underlying meta-model. For example, the meta-model 50 in FIG. 6 is instantiated to a model 60 in which the salve 62 is an AED, and the victim is believed to be likely suffering from a cardiac arrest within a room of a building. In this case, two human agents (EMTs 64) have been added to the model 60, who are transported in an ambulance and perceive things about the victim and the room. One of the EMTs call for shock and activates the AED to deliver a shock to the victim.

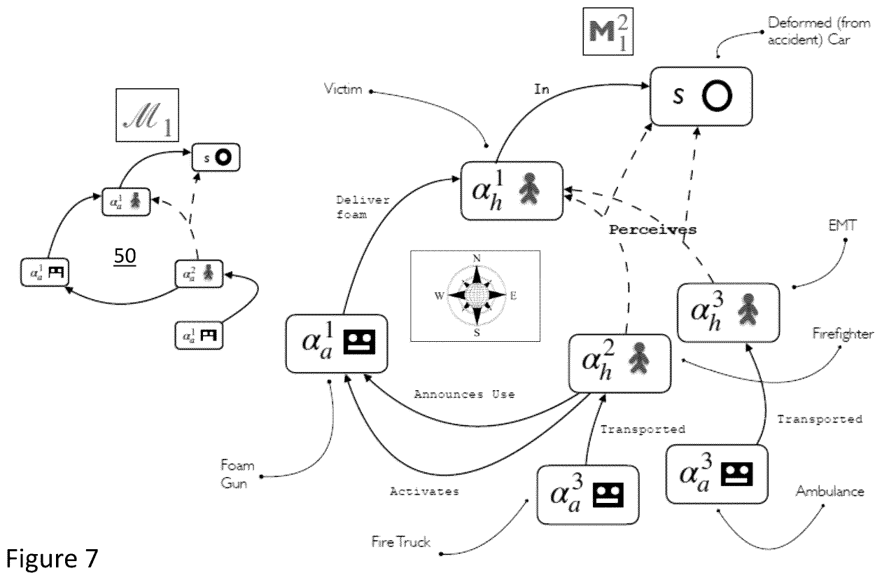

FIG. 7 depicts a different instantiation of meta-model 50, i.e., model 70 for addressing an extraction and fire emergency with an EMT and a firefighter. The model 70 depicts a timepoint at which the victim has been extracted (i.e., deformed from the car) and brought a safe distance away, by the pair of responders. However, the fire danger is still-present as expressed by perceptions of the EMT and firefighter, as well as the use of the foam gun on the victim.

Referring again to FIG. 1, as incoming information 40 is dynamically collected and logicized into [symbol] ERR, the platform 10 formally models (and remodels) the emergency situation in its environment. With the generation of each new model through time, a goal γ is generated (the reaching of which is believed by the system to address the emergency in question), and a plan is generated for reaching this goal. As noted, planning, which is a longstanding sub-area of AI, may be done with the use the planner Spectra. Planning is the task of finding a procedural course of action for a declaratively described system to reach its goals while optimizing overall performance measures. Automated planners find the transformations to apply in each given state out of the possible transformations for that state. Spectra is unique, however, in that it can be tasked with the job of automatically finding plans that involve or make changes in a purely mental space, in order to perhaps achieve goals that are themselves mental, or psychological. Mass-shooting emergencies provide a case in point, because sometimes after the active shooting has stopped, hostages may be held, and the shooter may enter into conversation with responders who are negotiators. In such a case, the goal γ may be that the shooter believes that he will not be shot upon surrender, and that he will be given an opportunity to broadcast his motivating views.

A plan to be executed can be transmitted to artificial agents able to directly address the emergency themselves, or given to human responders for them to resolve matters on their own, or to both human and artificial agents so that they can collaboratively resolve the emergency.

Platform 10 uses a background ontology for emergency response and resolution events. This ontology consists of the key properties, functions, actions, and objects frequently operative in the case of emergencies. For example, in the hypergraphical meta-model 50 shown in FIG. 5, various categories are used, including, e.g., salves (tourniquets, fire extinguishers/hoses, AEDs, splints, etc.), which are sometimes themselves artificial agents (e.g., an AED device is an artificial agent, because its actions are produced by functions operating computationally on its percepts, e.g., whether a sinus rhythm is in place or not; and if not, no shock will be advised by this agent, in an announcement to human responders present); Human Agents, specifically often a Responder (firefighters, EMTs, police, etc.) and at least one Victim. Also included are Vehicles (fire engines, ambulances, ladders, etc.). Every artifact that operates in whole or in part via computation is classified as an artificial agent, otherwise it is a mere Tool in the ontology.

Platform 10 in its entirety is based upon reasoning that is both nonmonotonic and inductive. Nonmonotonic (or, equivalently, defeasible) reasoning, has long been present in and judged important in logic-based AI. Nonmonotonic reasoning is distinguished by the fact that the arrival of new information can vitiate prior proofs. Deductive reasoning, in stark contrast, is monontonic. The nonmonotonicity/defeasibility of the cascading process is shown in FIG. 2, which indicates that both models and plans at a timepoint t, might need to be discarded in light of newly arrived percepts or parsed information. A model can be rejected in light of new information parsed and/or perceived. In that case a new model must be generated. Initially, the model may say that a fire is located at one place in one type of structure. Given this, a plan may make use of a water supply (e.g., a hydrant) at some location. However, new information will inevitably become relevant. For example, perhaps the location of the fire was wrong from the dispatcher or from the person who called the dispatcher; accordingly, a new model is needed and thus a new plan is formed. The platform is inductive because all reasoning is based on likelihood/probability, i.e., nothing is certain (except for mathematics and the role it sometimes plays in emergency response).

As is evident, NL Understanding (NLU) is an important aspect of the platform. Recall above the sample English sentence s, and the corresponding formula s>. The process of parsing sentences into formulae may for example be automated using the following methods in which NL regarding an emergency is converted into formal content suitable for supporting model generation and plan generation.
1. NLU Method 1. The first method is based upon a dedicated proper subset of English L_{ERR}, a dedicated natural language that is a proper part of the full language of, e.g., English, which for example includes and is limited to words, phrases, constructs, etc., associated with emergency response and rescue. [symbol] ERR is a dedicated formal language engineered for modeling of and planning of emergency response, of which L_{ERR} is the English counterpart of the formal language [symbol] ERR: L_{ERR}. The proper part of English restricts that lexicon and grammar of English to focus on emergencies and the natural language used as emergencies are handled. The key property of [symbol] ERR is that it is a theorem that every grammatically correct English sentence in this language can be algorithmically (and in fact in efficient (indeed, linear) time on the size of the input) mapped to its corresponding formula in [symbol] ERR. Thus, there is a direct correspondence between L_{ERR} and [symbol] ERR such that any well-formed sentence/expression in the former has a direct correlate in the latter such that the former can be directly parsed by platform 10. [symbol] ERR is accordingly as subset [symbol] , which is the enhanced formal language for the enhanced logic/cognitive calculus CC+ utilized herein.
2. NLU Method 2. The second method of NLU in the invention involves pre-processing by a trained Large Language Model of the raw natural language used by human emergency-response personnel. The most important data used for such training are English correlated to formulae in L_{ERR}. These correlates can be used to algorithmically generate many examples of English sentences that correspond directly to the underlying formulae that express them. An algorithm for such generation is in fact straightforward. S, let Σ be a vast collection of English sentences of this type. This pre-processing takes in raw English and, with the prompt to modify it so that it is closer, sentence by sentence, to the kind of English given in Σ. Once the pre-processing is finished, the English sentences obtained therefrom are given as input to NLU Method 1.

Referring again to FIG. 1, meta-model creator 24 is utilized to create meta-models of situations seen in emergencies. Fortunately, vast numbers of case studies of emergencies have been recorded. Such studies are for example numerous in the pedagogical materials for each sector of emergency response, from fire-fighting to emergency medicine to law enforcement, and beyond. All of these case studies can be used as raw material to manually create corresponding models, of both the symbolic, formula-based type, and the hypergraphical variety. With these models as input, abstract schemata for the particulars in these models can be automatically induced.

Cognitive calculi, as provided in FIG. 8, can be utilized to model event, actions, temporal changes, participants, cognitive elements of participants (e.g., beliefs, actions, emotions, etc.), etc., and generate plans. Each generated plan, as implemented, meets certain established criteria, e.g., achieves a goal, abides by existing laws or rules, minimizes property loss, etc.

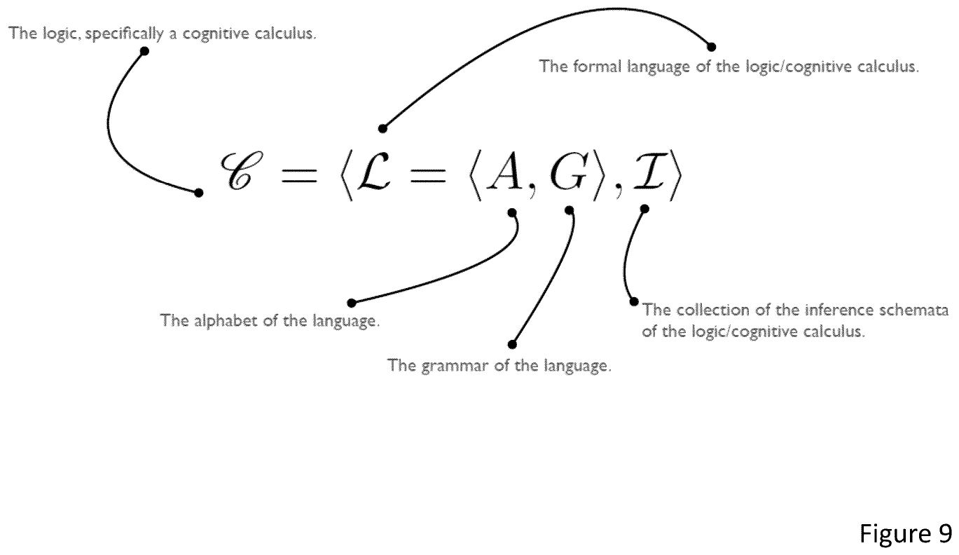

FIG. 9 depicts an overview of a high-level anatomy of cognitive calculus. Further details of which are provided in Bringsjord, S.,˜Govindarajulu, N. S.,˜Licato, J. & Giancola, M. (2020) “Learning Ex Nihilo” in Proceedings of the 6th Global Conference on Artificial Intelligence (GCAI 2020), within International Conferences on Logic and Artificial Intelligence at Zhejiang University (ZJULogAI), in Danoy, G., Pang, J. & Sutcliffe, G., eds., 72: 1-27 (Manchester, UK: EasyChair Ltd), EPiC Series in Computing, ISSN: 2398-7340. http://kryten.mmspi.edu/SBringsjord_etal_LearningExNihilo040620.pdf, which is incorporated by reference.

Platform 10 may utilize various formalisms (i.e., systems of computational formal logic), and on implementations of each of these two formalisms, e.g., cognitive calculi and shadow prover. A first formalism is a collection of highly expressive formal computational logics (they are quantified multi-modal logics), known as cognitive calculi. Each member of this collection is a particular cognitive calculus; the specific cognitive calculus known as the cognitive event calculus is employed in the described embodiments. A recent detailed account of this calculus is, e.g., given in: (Govindarajulu & Bringsjord 2017a, Govindarajulu & Bringsjord 2017b).

An important, distinctive aspect of cognitive calculi is that they are expressive enough to represent a “theory of mind” level in which cognitive states are expressed, including e.g., what a participant in a domain believes, knows, intends, perceives, desires, communicates, emotes, and so on. Because emergencies often have the property of humans perceiving and reacting to events, it may be necessary to use cognitive calculi. Standard logics, e.g., first-order logic and fragments thereof, which are used in most AI work, are inadequate to capture theory of mind elements.

FIG. 8 shows a progression of six increasing powerful formal languages. At Level 6, the most expressive, there exist the formal languages used in cognitive calculi. In this embodiment, there are six ascending levels of computational logics in the hierarchy. The first three levels involve logics that found in the database world. Level 1 includes a resource description framework (RDF), which is a model for data publishing and interchange on the Web. At level 2 is propositional calculus (PC), which is a branch of symbolic logic that deals with propositions and the relations between them, without examination of their content. Level 3 provides for the use of description logic (DL), which is a family of formal knowledge representation languages.

Levels 4-6 provide systems unique to the inventive processes described herein. Namely, Level 4 provides for multi (i.e., many)-sorted logic (MSL). Level 5 provides for the addition of intensional operators to PC and RDF, which allows for modeling what real actors believe, know, intend, perceive, etc. Finally, level 6 provides cognitive calculi in which the intensional operators are allowed to range over quantificational formulae, such that full plans involving human actors can be developed. The concept of cognitive calculi is for example detailed in Govindarajulu, N. S. & Bringsjord, S. (2017) “On Automating the Doctrine of Double Effect” in Sierra, C., ed., Proceedings of the Twenty-Sixth International Joint Conference on Artificial Intelligence (IJCAI-17), International Joint Conferences on Artificial Intelligence, publisher; pp. 4722-4730. ISBN (Online): 978-0-9992411-0-3. DOI: 10.24963/ijcai.2017/658, which is hereby incorporation by reference.

As is well-known, the job of a planner in AI is to automatically find plans that, if followed, reach desired goals. Platform 10 provides a logic-based planning system 30 that greatly exceeds what is known in AI as classical “STRIPS-based” or “STRIPS-style” planning.

Classical STRIPS-based planning is pitched at the level of the propositional-calculus (Level 2), or at the level of proper subsets of first-order logic (Level 3). The present planner, e.g.,

Spectra, operates at both the level of full first-order logic and multi-sorted logic (Level 4), and the level of quantified multi-modal logics (i.e., at the level of cognitive calculi, Level 6). Spectra allows the AI to plan in unbounded or infinite domains (e.g., domains over N, the natural numbers, or domains with a large number of objects and build plans taking into account, and changing, cognitive states (e.g., beliefs of other agents). An overview of Spectra, the expressive planning system, and source code, is provided at https://naveensundarg.github.io/Spectra/. As noted, this may involve planning at the “theory-of-mind” level. Using theory of mind logic, plans can be found that achieve goals including the targeted cognitive states of human agents, e.g., beliefs, emotions, etc. For example, if actors in a domain are known to have particular thought processes, biases, etc., they can be represented, and be used to evaluate and formulate plans. Theory of mind logic allows the cognitive states of all human participants to be captured, and can, e.g., help ensure that plans involving humans will achieve a goal.

As noted, real world semantic information 12 is utilized by the planning system 30, and may be collected and compiled into one or more formalized logics based languages such as MSL and CEC. This may for example include laws and rules (i.e., regulations, policies, etc.) expressed as formulae, as well as processes expressed as formulae. Processes generally include a series of events that are related temporally or by some action. For example, a process in the fire emergency domain may comprise: receive a report; dispatch trucks to the site; identify water supply; extinguish the fire. Additionally, knowledge bases of domain participants are represented using cognitive calculi, such that their cognitive states are expressed. Finally, plans or partial plans (e.g., previously generated) may be provided and used to ensure that newly generated plans will achieve a goal.

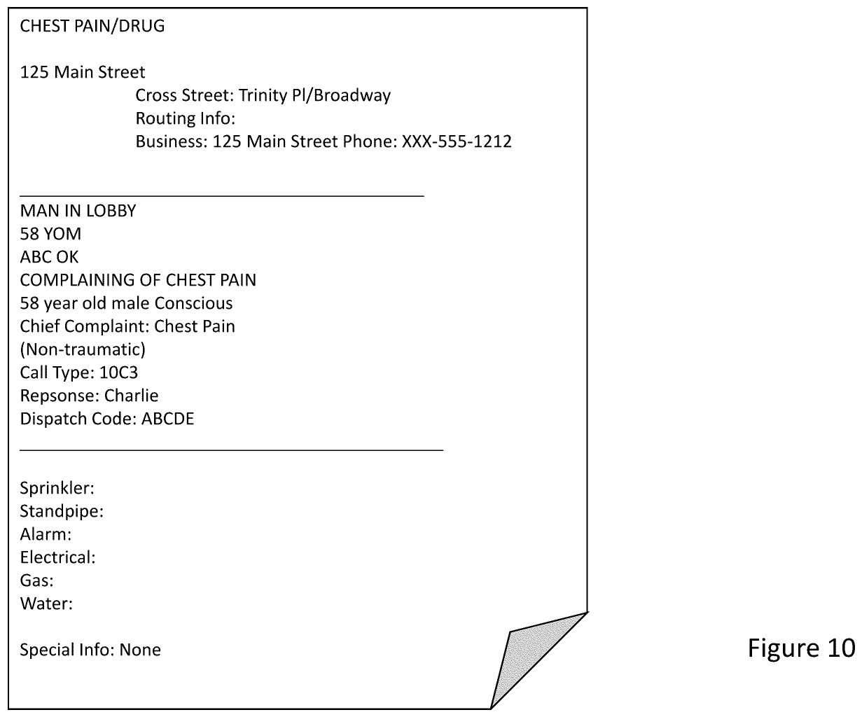

An illustrative use case of platform 10 involves a call to a fire-department (FD) dispatcher produces what is called a “rip-and-run.” Addresses and information are manually typed in by the dispatcher, and then printed out and/or faxed, as shown in FIG. 10. Platform 10 would capture all this information in real-time, translate it into the [symbol] ERR language, automatically generate an initial model, and generate based on that model a plan for the response. The model and plans are updated as needed when time moves forward and new information is obtained by perception and parsing. For instance, suppose that in this emergency an active model includes a fire hydrant as something that can provide resolution, or at least contribute to resolution. However, uncertainty may exist as to whether the hydrant's location, relative to the presumed location of the fire, is close enough. A more refined model can be automatically generated, based on maximum length of fire hose available in an accessible fire truck, and upon GPS location data of the fire hydrant. Given that in the active model the distance from said hydrant to the burning structure known, along with the length of firehose, and a number of other relevant factors are pinned down as well, platform 10 can generate a plan to park a particular firetruck at a particular location, and connect and spin out the designated hose.

Platform 10 accordingly will enable responders, such as fire departments, to respond in rapid fashion by following plans based upon spatially accurate and informative modes. Fire departments will have no need to search and guess about fire hydrant locations and the like upon arriving at the site of a fire. Existing services, such as Google and Apple Maps provide precise locations not just of building structures, but of fire hydrants themselves, which can be accessed by platform 10. Platform 10 will access such data, parse it in real-time in the language L ERR, automatically generate a model that includes the distance from the hydrant to the structure, and provide a plan to address the fire. The chauffeur/pump operator in this case does not investigate, measure, and guess where the best water source is. Rather, they can simply follow a plan that will reduce time to address the emergency.

Currently, as said, hydrant locations are known, but none of these data-points, are used to build models that include the relevant agents, available actions, rational beliefs, and natural-language communication between responders throughout time that are all intertwined in a firefighter response.

In various embodiments, platform 10 can be implemented in intelligent software used by dispatchers first, and then the information will be sent via smart devices, such as handheld mobile devices to all agents involved upon receiving the call. The platform reduces guessing and estimations out of life saving situations. This system can be downloaded and locally installed not just on all smart phones, tablets, etc., but also in all smart appliances, e.g., a smart refrigerator in a firehouse could have all this information generated visually on screen or verbally.

Platform 10 may be applied to many kinds of emergencies beyond the types mentioned herein, e.g., usage could apply in, e.g., police departments, ski patrol headquarters, department of homeland security, search and rescue, etc. Being able to intelligently represent and automatically generate information pertaining to a vehicle, human agent, safety equipment, life saving devices, and more will enable use of a system like the fire hydrant system to remove judgment, subjectivity, human error, and more from any life endangering situation.

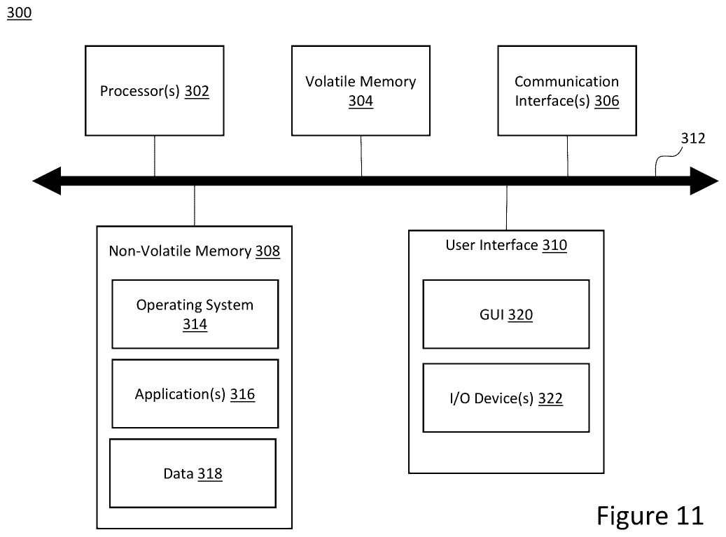

Elements of the described solution may be embodied in a computing system, such as that shown in FIG. 11 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 25 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

What is claimed is:

1. An artificially intelligent emergency response system, comprising:
a memory; and
a processor coupled to the memory and configured to generate a plan for an emergency event in response to received event information from one or more input devices, according to a process that includes:
translating the received event information into a logically controlled natural language;
selecting a meta-model that conforms to the emergency event;
generating a hypergraph model from the meta-model, wherein the hypergraph model includes details from the received event information;
generating a goal based on the received event information; and
generating and outputting a plan to an output device based on the hypergraph model, the goal, and semantic information.

2. The system of claim 1, further comprising:
receiving new event information;
translating the new event information to the logically controlled natural language;
analyzing the new event information with an automated reasoner to determine whether a current model is viable; and
generating a new model if the current model is no longer viable.

3. The system of claim 2, further comprising:
analyzing the new event information with the automated reasoner to determine whether a current plan is viable; and
generating a new plan if the current plan is no longer viable.

4. The system of claim 1, wherein the logically controlled natural language is implemented with cognitive calculi.

5. The system of claim 1, wherein the hypergraph model comprises nodes that represent human and artificial agents.

6. The system of claim 5, wherein each node includes:
a function that defines a percept to action capability of the agent;
a set of formulae in the logically controlled natural language that defines attributes of the agent; and
a set of dependencies that the agent depends upon.

7. The system of claim 6, wherein the attributes are configured to store beliefs, knowledge, intensions, and perceptions of the agent.

8. The system of claim 3, wherein new event information originating from a human is assigned a cognitive-likelihood value.

9. The system of claim 8, wherein the cognitive-likelihood value is utilized to evaluate viability of the current model and current plan.

10. The system of claim 1, wherein the plan is displayed on the output device as an annotated hypergraph.

11. The system of claim 10, wherein the annotated hypergraph includes geospatial information.

12. The system of claim 10, wherein the annotated hypergraph is periodically updated with new event information.

13. A artificially intelligent method for implementing an emergency response plan, comprising:
receiving event information from one or more input devices;
translating the received event information into a logically controlled natural language;
selecting a meta-model that conforms to the emergency event;
generating a hypergraph model from the meta-model, wherein the hypergraph model includes details from the received event information;
generating a goal based on the received event information; and
generating and outputting a plan based on the hypergraph model, the goal, and semantic information.

14. The method of claim 13, further comprising:
receiving new event information;
translating the new event information to the logically controlled natural language;
analyzing the new event information with an automated reasoner to determine whether a current model is viable; and
generating a new model if the current model is no longer viable.

15. The method of claim 14, further comprising:
analyzing the new event information with the automated reasoner to determine whether a current plan is viable; and
generating a new plan if the current plan is no longer viable.

16. The method of claim 13, wherein the logically controlled natural language is implemented with cognitive calculi.

17. The method of claim 13, wherein the hypergraph model comprises nodes that represent human and artificial agents.

18. The method of claim 15, wherein each node includes:
a function that defines a percept to action capability of the agent;
a set of formulae in the logically controlled natural language that defines attributes of the agent; and
a set of dependencies that the agent depends upon.

19. The method of claim 18, wherein the attributes are configured to store beliefs, knowledge, intensions, and perceptions of the agent.

20. The method of claim 15, wherein new event information originating from a human is assigned a cognitive-likelihood value.
